(19) United States
(12) Patent Application Publication
(10) Pub. No.: US 2016/0283953 A1
(43) Pub. Date: Sep. 29, 2016

(54) DEMAND-SUPPLY MATCHING WITH A TIME AND VIRTUAL SPACE NETWORK

(71) Applicant: International Business Machines Corporation, Armonk, NY (US)

(72) Inventors: Markus R. Ettl, Ossining, NY (US); Pavithra Harsha, White Plains, NY (US); Shivaram Subramanian, New Fairfield, CT (US); Joline Ann V. Uichanco, Ann Arbor, MI (US)

(21) Appl. No.: 14/669,273

(22) Filed: Mar. 26, 2015

(51) Int. Cl. G06Q 30/02; G06Q 10/08

(52) U.S. Cl. CPC G06Q 30/0202; G06Q 10/087

(57) ABSTRACT

In one embodiment, a computer-implemented method includes receiving historical transaction data related to a product. A demand model is calibrated to forecast demand for each of one or more zones and each of one or more channels over which the product is sold. A time-and-virtual-space (TVS) network is constructed, by a computer processor, to include one or more supply nodes and one or more sink nodes. Each of the supply nodes represents inventory of the product at a corresponding physical location, and each of the sink nodes represents a calibrated demand for the product. Based on the TVS network, a low-cost plan is determined for an omni-channel retail environment. The low-cost plan specifies at least one of allocation of the product across physical stores, partitioning of the inventory of the product for virtual sales, and pricing of the product.

### BACKGROUND

Various embodiments of this disclosure relate to supply and demand matching and, more particularly, to demand-supply matching with a time and virtual space network.

In line with a recent revolutionary trend in the retailing industry, retail firms often adopt omni-channel strategies. In an omni-channel retail environment, a firm aims to provide a seamless experience for customers to access multiple channels in purchasing goods. For example, a customer may visit a retail store to physically browse items, and then order online from the same retailer. Alternatively, a customer may order online but then pick up the purchased item at a retail store. In today's increasingly mobile world, where prices across a retailer's sales channels are available to customers, customers increasingly engage in channel-switching behavior due to differences in price cadences across channels.

Many retailers are making concerted strategic decisions to break down traditional boundaries between channels in the design of their retail supply chains. For example, retailers recognize their network of brick-and-mortar stores can also serve the purpose of a network of mini-warehouses to fulfill e-commerce sales. This is accomplished through multiple cross-channel fulfillment alternatives, including the retailer-initiated ship from store (SFS) option (i.e., the retailer opts to fulfill an e-commerce sale from one of its stores, which picks, packs, and ships the product to the customer's address) and the customer-initiated buy-online-pickup-in-store (BOPS) option (i.e., the customer chooses to pick up the product from a nearby store).

A hallmark of an omni-channel retail environment is that inventory is shared across channels, both from the customer's perspective and from the retailer's perspective. In the customer's perspective, he or she can choose a channel to purchase from based on the price and convenience. In the retailer's perspective, it has the ability to choose a channel to fulfill a transaction.

### SUMMARY

In one embodiment of this disclosure, a computer-implemented method includes receiving historical transaction data related to a product. A demand model is calibrated to forecast demand for each of one or more zones and each of one or more channels over which the product is sold. A time-and-virtual-space (TVS) network is constructed, by a computer processor, to include one or more supply nodes and one or more sink nodes. Each of the supply nodes represents inventory of the product at a corresponding physical location, and each of the sink nodes represents a calibrated demand for the product. Based on the TVS network, a low-cost plan is determined for an omni-channel retail environment. The low-cost plan specifies at least one of allocation of the product across physical locations, partitioning of the inventory of the product for virtual sales, and pricing of the product.

In another embodiment, a system includes one or more computer processors configured to receive historical transaction data related to a product. The one or more computer processors are further configured to calibrate a demand model to forecast demand for each of one or more zones and each of one or more channels over which the product is sold. The one or more computer processors are further configured to construct a time-and-virtual-space (TVS) network including one or more supply nodes and one or more sink nodes. Each of the supply nodes represents inventory of the product at a corresponding physical location, and each of the sink nodes represents a calibrated demand for the product. The one or more computer processors are further configured to determine, based on the TVS network, a low-cost plan for an omni-channel retail environment. The low-cost plan specifies at least one of allocation of the product across physical locations, partitioning of the inventory of the product for virtual sales, and pricing of the product.

In yet another embodiment, a computer program product for planning in an omni-channel retail environment includes a computer readable storage medium having program instructions embodied therewith. The program instructions are executable by a processor to cause the processor to perform a method. The method includes receiving historical transaction data related to a product. A demand model is calibrated to forecast demand for each of one or more zones and each of one or more channels over which the product is sold. A time-and-virtual-space (TVS) network is constructed to include one or more supply nodes and one or more sink nodes. Each of the supply nodes represents inventory of the product at a corresponding physical location, and each of the sink nodes represents a calibrated demand for the product. Based on the TVS network, a low-cost plan is determined for an omni-channel retail environment. The low-cost plan specifies at least one of allocation of the product across physical locations, partitioning of the inventory of the product for virtual sales, and pricing of the product.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a planning system, according to some embodiments of this disclosure;

FIGS. 2A-2B are a diagram of a time-and-virtual-space (TVS) network, according to some embodiments of this disclosure;

FIG. 3 is a diagram of a particular zone in the TVS network, according to some embodiments of this disclosure;

FIG. 4 is a flow diagram of a method for determining inventory allocation, partitioning, and pricing, according to some embodiments of this disclosure; and

FIG. 5 is a block diagram of a computing device for implementing some or all aspects of the planning system, according to some embodiments of this disclosure.

### DETAILED DESCRIPTION

Various embodiments of this disclosure plan inventory pricing, allocations, and partitions for all channels simultaneously in an omni-channel environment, based on a dynamic time-and-virtual-space (TVS) network. Because customers can switch between channels, and because of the various available fulfillment options, an omni-channel environment presents difficulty with respect to deciding pricing and inventory.

Conventional supply chain models, which optimize for inventory and prices for distinct sales channels independently, fail to model cross-channel interactions of demand and supply. From a supply chain management perspective, in an omni-channel environment, a retailer should understand demand patterns across channels and locations so as to plan for inventory allocations as well as inventory partitions and to reduce shipping costs. From a revenue management perspective, setting prices based on these traditional models runs the risk of cannibalizing the retailer's own market share and losing potential revenue. For example, in an omni-channel environment, a portion of a brick-and-mortar store's inventory might be used to fulfill online demand through cross-channel fulfillment options. However, since the conventional, single-channel price optimization models do not take this into consideration, these models will result in steep markdowns in brick-and-mortar stores to increase brick-and-mortar channel sales.

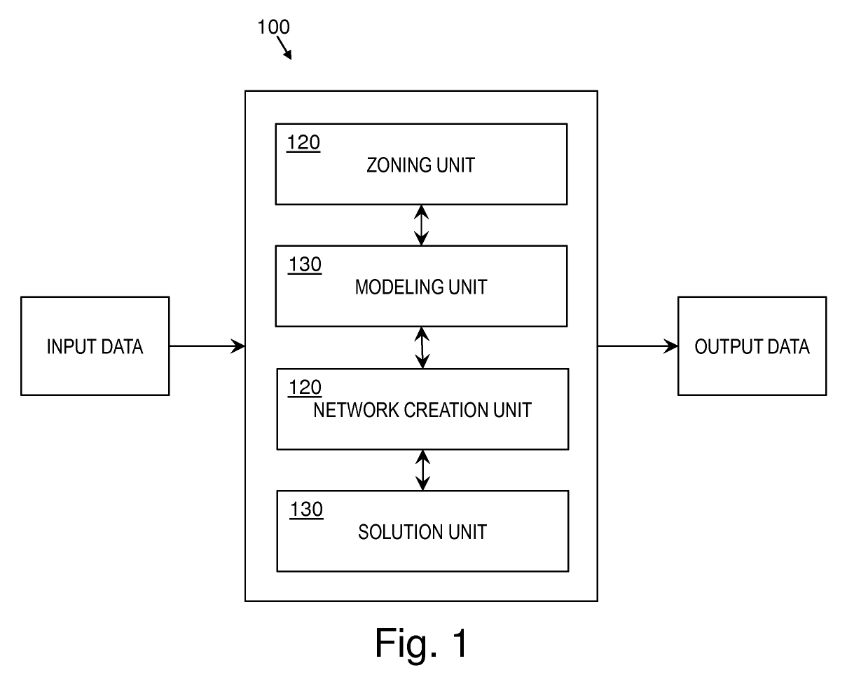

FIG. 1 is a block diagram of a planning system 100, according to some embodiments of this disclosure. The planning system 100 may determine for a retailer how to price, allocate, and partition inventory, such as inventory for a short-lifecycle product. According to this disclosure, a short-lifecycle product is an item for which a retailer has limited inventory, which may be spatially distributed across warehouses and physical stores. Further, “allocation” refers to the allotment of inventory to a certain location or zone, and “partition” refers to a portion of inventory at a brick-and-mortar location that is reserved for virtual sales channels (e.g., online sales).

As shown in FIG. 1, input data related to a product may be input into the planning system 100. In some embodiments, this product may be a group of products being considered as a unit. The input data related to the product may include, for example, transaction data, physical (i.e., brick-and-mortar) stores and warehouse locations, sales time-series data, inventory time-series data, fulfilment history, product UPC, unit cost, return rates, customer demographic data including billing and shipping zip codes, prices, promotions, holiday events, weekly seasonality profiles, and competitor price time-series data. The transaction records in the input data may be geo-tagged. For example, and not limitation each transaction in the transaction data may be associated with a zip code or other location data indicating a location from which the customer made the transaction. For further example, the location data may indicate a brick-and-mortar store or, in the case of an online transaction, the customer's home or mobile device. For example, in the latter case, the location data may include the billing or shipping zip code, or both, for the online transaction.

The planning system 100 may include various operational units, which may each be made up of hardware, software, or a combination of both. These operational units may include, for example, a zoning unit 110, a modeling unit 120, a network creation unit 130, and a solution unit 140. Generally, the zoning unit 110 may use some or all of the input data to create geographical sales regions, also referred to herein as zones; the modeling unit 120 may use a demand model based on historical sales to estimate sales of the product; the network creation unit 130 may create a TVS network using the established zones and the demand model; and the solution unit 140 may determine pricing, allocations, and inventory based on the TVS network. It will be understood that, although these operational units are shown as distinct components in FIG. 1, this distinction is made for illustrative purposes only. These units may include overlapping hardware, software, or both, or may be further divided based on implementation preferences. As further shown in FIG. 1, the planning system 100 may provide output data indicating how to price, allocate, and partition inventory of the product.

The planning system 100 may use some or all of the input data to establish zones, which are geographical sales regions. A zone may be a geographical area that covers one or more transaction locations, where a transaction location may include zero or more physical stores and zero or more addresses or zip codes used by customers when making purchases through virtual (e.g., online) channels. For example, a first zone may include two stores in the Atlanta metro area as well as numerous homes of customers who purchased online in or around the Atlanta metro area. Various clustering mechanisms, such as K-means clustering, exist in the art for dividing special data into regions, and such mechanisms may be used for establishing zones based on the input data.

The TVS network eventually constructed by the planning system 100 may include data that is based on historical demand. To this end, the planning system 100 may use a demand model. As mentioned above, as part of the input data, the planning system 100 may receive transaction data, which may include location data for transactions; inventory data; and demand attributes, such as price data. This input data may be used to calibrate time-series models for channel-zone demand forecasts. Below, an omni-channel demand model for this purpose is described.

Consider an omni-channel retailer selling a short-lifecycle product over a time horizon T in L different zones, where customers can choose to purchase from any of the retailer's M sales channels (e.g., physical stores, e-commerce, mobile). Let Zₜₗₘ be the vector of demand attributes (e.g., price, promotion, seasonality, holiday, and competitor prices in the same channel or other channels) of the product at time tεT in zone lεL and channel mεM. Let Zₜₗ=[Zₜₗ₁; Zₜₗ₂; . . . ; Z_{t|M|}], where |M| refers to the cardinality of the set M, be the corresponding matrix of attributes for all M channels. A customer at time t and location l chooses the channel to purchase from based on the matrix of channel attributes. Herein, Dₜₗ(Zₜₗ) denotes the vector of channel demands at time t and location 1. This is an omni-channel demand model because the demand in a specific channel is allowed to depend on the attributes in other channels, such that cross-channel interactions may be accounted for.

Various demand models exist in the art and may be used by the planning system. Specifically, some embodiments of the planning system 100 may use an attraction demand model. Attraction demand models are commonly used demand functions to model consumer choices in marketing, economics, and revenue management. These models generalize the well-known multinomial logit (MNL) and the multiplicative competitive interaction (MCI) demand models. Some alternative embodiments of the planning system 100 may use a scan-pro demand model that explicitly captures pair-wise cross elasticities including complementary effects, or a the hybrid demand model that combines the scan-pro demand model for market size and the attraction demand model for market share.

According to some embodiments, an attraction demand model to model customers' channel purchase choices may take the following form: Dₜₗₘ (4)=market size of zone l at time t* market share of channel m in zone l at time t

$${D}_{tlm} ( {Z}_{tl} ) = {τ}_{tl} \frac{{f}_{tlm} ( {Z}_{tlm} )}{1 + {\sum }_{{m}^{′} ∈ M {f}_{{tlm}^{′}}} ( {Z}_{{tlm}^{′}} )}$$

In the above equation, τₜₗ is the market size of zone l at time t, and fₜₗₘ (Zₜₗₘ) is the attraction function of customers in zone l to channel m. For example, appropriate attraction functions may include fₜₗₘ(Zₜₗₘ)=e^{a}^{ₜₗₘ}+bₜₗₘ^{T}Zₜₗₘ, where aₜₗₘ and bₜₗₘ are estimated demand parameters in the case of the MNL demand model, and fₜₗₘ(Zₜₗₘ)=aₜₗₘΠ_{m′}Z_{tlm′}^{b}^{ₜₗₘ}′ where aₜₗₘ and b_{tlm′} are estimated demand parameters in the case of the MCI demand model.

To estimate this demand function, the planning system 100 may calibrate the selected demand model with historical sales data originating from each channel in every zone lεL. For example, and not by way of limitation, calibration may use a regression or maximum likelihood approach. In particular, as mentioned above, transaction data provided to the planning system 100 may include zip code information, or other location data, which may be used to segment the transaction data in this estimation procedure.

Even with historical sales information, estimating an attraction demand model may also require knowledge of a lost-sales component. Various methods for determining lost sales exist in the art and may be used by the planning system 100. These methods include, for example, the Expectation-Maximization (EM) technique and Newman's 2-step approach. In both these example methods, the attraction model may be fitted based on a maximum-likelihood approach.

Based on the calibrated demand model, the planning system 100 may determine a time-series demand forecast for each combination of channel and zone.

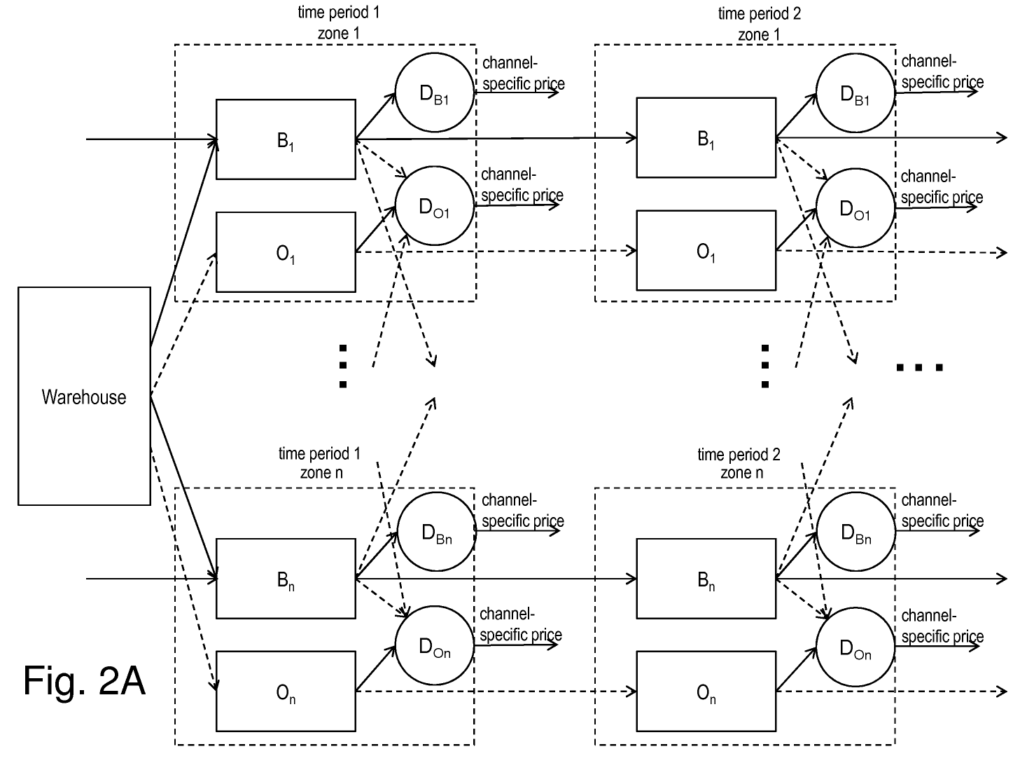

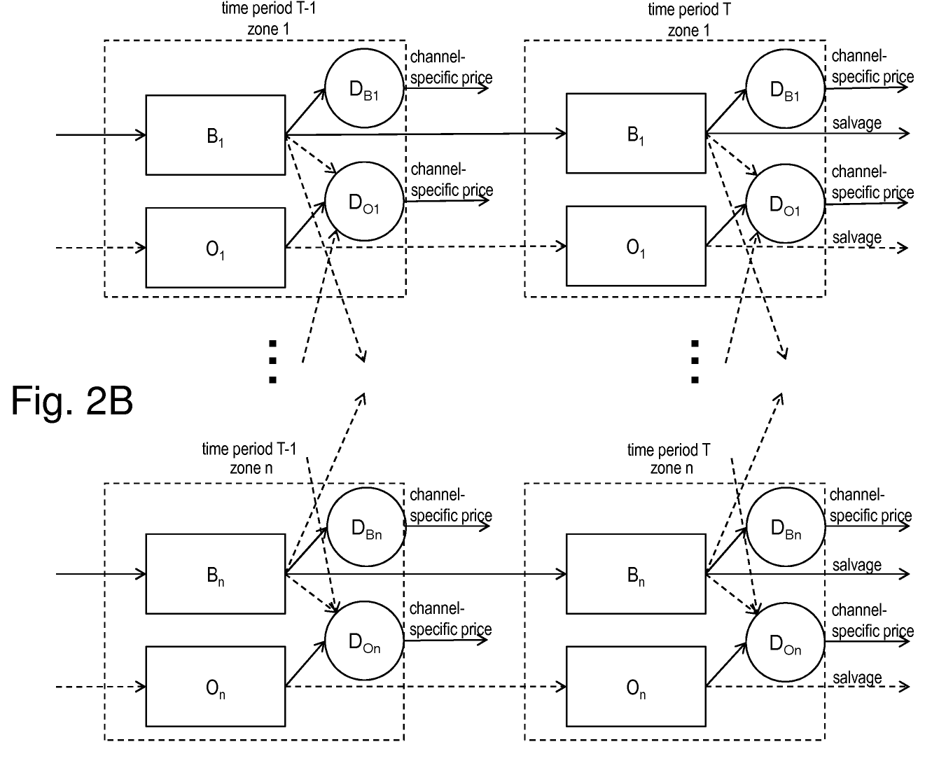

FIGS. 2A-2B are a diagram of a TVS network 200, according to some embodiments of this disclosure. FIG. 2A illustrates the beginning of the TVS network 200, which flows horizontally into the FIG. 2B, which represents the end of the TVS network 200. To build the TVS network 200, the planning system 100 may use the established time-series demand forecasts by channel and zone 230 to model inventory flows that match the demand, through determining the following: (1) initial inventory allocations by channel and store location, (2) partitioning of physical store inventory, and (3) cross-channel fulfillment flows. For simplicity, it is assumed in the example of FIGS. 2A-2B that a single warehouse fulfills online demand. However, it will be understood that, using the framework described herein, the planning system 100 may work for an omni-channel environment with multiple warehouses, or for environments with no warehouse where online demand is fulfilled through cross-channel inventory only.

The TVS network 200 may include supply nodes 210 and sink nodes 220. The supply nodes 210 may represent inventories in physical locations, such as the warehouses and individual physical stores, while the sink nodes 220 may represent calibrated demands for the product in question. These calibrated demands may be taken from the time-series demand forecasts previously established. In an omni-channel environment, all channels and zones may share inventory. Whenever inventory is used to meet a demand in response to a sale, the retailer gets receives a profit in the channel where the sale was made, and the inventory may be evaluated at the channel price. Unused inventory may be passed to a sink 220 node in the TVS network 200 and may be valued at salvage, which may result in a profit equal to the salvage price.

As the inventory flows through the TVS network 200, there may be costs associated with that flow. These costs may include, for example, transportation costs from warehouses to stores, as well as shipping costs associated with fulfillments (e.g., warehouse to customer, store to customer). The planning system 100 may seek a low-cost or minimal-cost route through the TVS network 200. Such a route may represent a flow of inventory and, thus, inventory allocations and partitions for that flow.

The TVS network 200 of FIGS. 2A-2B shows the flow of inventory across time (horizontal flows) and across channels and zones 230 (vertical flows). For a given time period t, each dashed box in FIG. 1 represents a zone 230, which may be a cluster of geographically proximate zip codes. In the example demonstrated by FIG. 1, there are n zones 230. At each zone 230, there may exist one or more sales channels. For simplicity, FIG. 1 illustrates only two channels, a brick channel (i.e., physical stores) and an online channel. However, it will be understood that the TVS network 200 network can be generalized for more than two sales channels. Also for simplicity, the illustration of the TVS network 200 in FIGS. 2A-2B aggregates inbound and outbound inventory flows by a combination of channel and location. However, in some embodiments, a TVS network 200 may instead have a separate node for each store in a given zone 230, reflecting the fact that store inventories are located physically in brick stores.

The inventory flow into block B₁ represents the total inventory physically located in the cluster of retail stores in Zone 1. The inventory flow into block O₁ represents the total inventory physically located in the warehouse but partitioned (i.e., reserved) for online demand originating from Zone 1.

Throughout FIGS. 2A-2B, the circles are sink nodes representing calibrated demands. Specifically, at time t, D_{B1} is a sink node for the brick channel in Zone 1, and this sink node receives an outflow magnitude equal to the demand forecast at time t for brick demand (i.e., the demand from brick stores) plus, if the retailer allows a buy-online-pickup-in-store (BOPS) option, the demand forecast at time t for online demand that will be picked up in a store in zone 1. At time t, D_{O1} represents the demand forecast at time t for online demand originating from Zone 1 minus, if the retailer allows a BOPS option, the online demand originating from location 1 that is forecasted to be picked up in a store.

The various edges, or arrows, in the TVS network 200 represent inventory flows. Each if such flows may be associated with a cost or an increase in revenue. It will be understood that some of the costs are zero, while others are more. The solid arrows represent inventory intra-channel flows within a channel. Intra-channel inventory flows from node B₁ may go only to fulfill same-channel demand D_{B1} (e.g., when a customer purchases and picks up within a retail store), which may incur no cost, or to the same node B₁ in the next time period, which may incur a per-unit holding cost. Analogously, intra-channel virtual inventory flows from node O₁ may go only to fulfill same-channel demand D_{O1}, which may incur a per-unit shipment cost, or to the same node O₁ in the next time period, which may incur a per-unit holding cost. Cross-channel inventory flows are represented by dashed lines. Cross-channel inventory may flow from a brick location B₁ to either an online demand sink in the same zone 230, which may incur a per-unit shipment cost, or to an online demand sink in another location D_{O1}, which may incur a per-unit shipment cost. The virtual flow of inventory from the warehouse to virtual locations, such as node O₁, is also illustrated by dashed lines. It will be understood that shipment costs, holding costs, and other costs may vary across nodes and across time periods.

Pricing and resulting revenue may be represented as an arrow extending from each sink node, which represents calibrated demand, or expected sales. The calibrated demand translates into an increase in revenue that is based on the price of the demanded quantity. Specifically, the revenue may increase by the channel-specific price per each multiplied by the calibrated demand. It will be understood that pricing may vary across nodes and across time periods.

The retailer using the planning system 100 may provide values for the above cost variables in the TVS network 200 based on actual costs, and these values may be applied to edges within the TVS network 200 and thus incorporated as edge costs. For a particular flow of inventory through the TVS network 200, the cost of that flow may be calculated as the sum of the edges included in the route of the flow through the TVS network 200. These edge costs may thus be used in a network flow algorithm applied to optimize inventory flows through the TVS network 200.

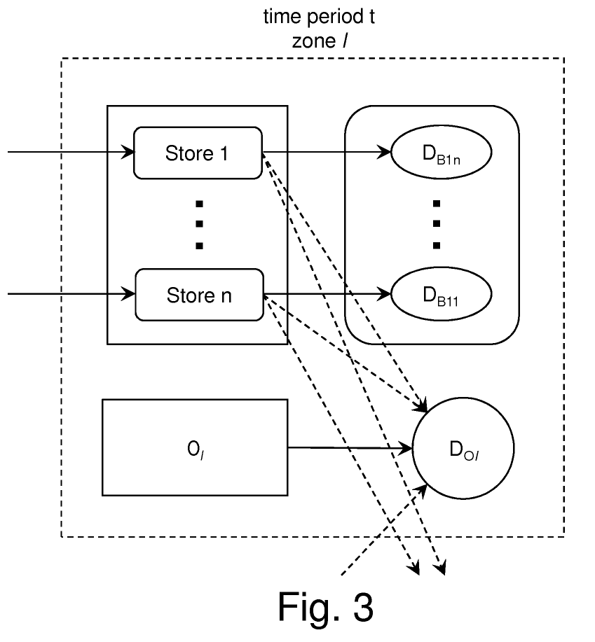

FIG. 3 is a diagram of a particular zone 230 in the TVS network 200 at a given time, according to some embodiments of this disclosure. More specifically, FIG. 3 illustrates the brick-and-mortar inventory further divided into inventories of physical stores within the zone 230. FIG. 3 illustrates that, in each zone 230, there may be one or more physical store nodes and demand nodes representing, respectively, physical stores and their respective demand. The physical stores in a given zone 230 may be equivalent to one another from the perspective of cost of flow, but they may differ in inventory levels. The demand profiles of stores in a given zone 230 may be assumed similar with respect to the customers' willingness to buy, but may be different in the market sizes per store.

Various solvers and algorithms exist for solving network flow problems. For example, in some embodiments, the TVS network 200 may be provided as input to a standard optimization solver package, such as IBM ILOG CPLEX, to identify minimum cost flows through the TVS network 200. When applied to the TVS network 200, a solver or network flow algorithm may provide as output a route through the TVS network 200 which may determine inventory allocations, partitions, and cross-channel fulfillments. If the demand forecasts depend on price, as is often the case with short-lifecycle products that have high elasticity, the prices may be assumed to be decision variables, and a joint price and inventory optimization problem may be solved over the TVS network 200, instead of just inventory flows as described above. More specifically, the planning system 100 may make an omni-channel markdown price determination together with an inventory determination can, even in the presence of business rules.

Embodiments of the planning system 100 may be extended to include models for demand uncertainty and models of joint price and inventory optimization, where prices in each zone and channel influence the calibrated demands. In such embodiments, the calculated inventory allocations, partitions, and pricing may be executed for a current time period. In the next time period, actual sales are generated in each channel and zone, creating new historical transaction data. The demand model may then be recalibrated based on the new transaction data, and the network flow problem over the TVS network 200 may be re-solved with the new starting inventory, resulting in new pricing and partitions. In such embodiments, the demand model may be recalibrated and the network flow problem re-solved repeatedly with a rolling time horizon.

Based on a network flow solution for the TVS network, the planning system 100 may generate output data. Specifically, for example, this output data may include physical store prices over time for each store location, virtual channel prices over time, demand and sales predictions for each store and each zone in the TVS network, the amount of the existing inventory at each store needed to meet store demands, the amount of existing inventory at each store to be used toward virtual channel demand, and product allocations from warehouses to stores.

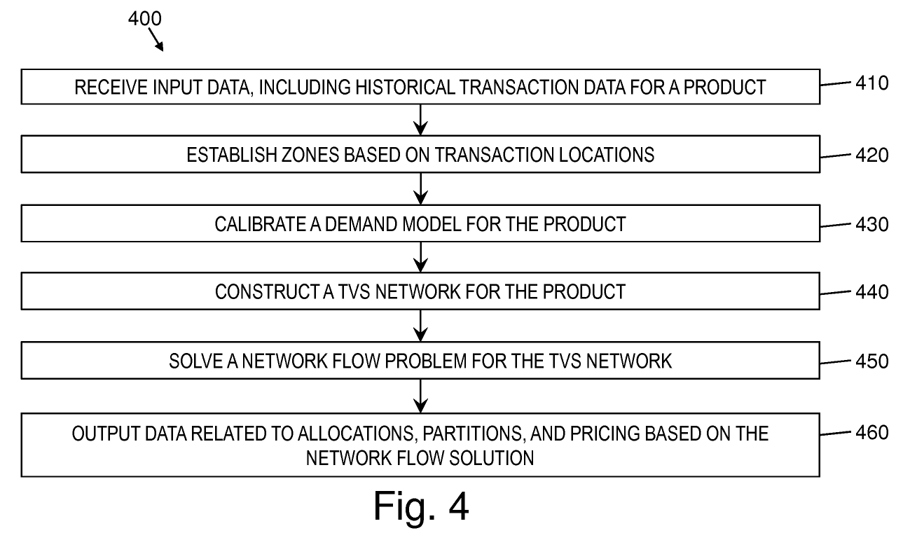

FIG. 4 is a flow diagram of a method for determining inventory allocation, partitioning, and pricing, according to some embodiments of this disclosure. As shown, at block 410, the planning system 100 may receive input data, including historical transaction data for a product. At block 420, the planning system 100 may establish one or more zones for clustering the transaction data, where each zone is a region covering various past transactions. At block 430, the planning system 100 may calibrate a demand model for the product. At block 440, the planning system 100 may construct a TVS network 200 representing potential inventory flows and the costs of such flows. At block 450, the planning system 100 may solve a network flow problem for the TVS network 200 to find a low-cost or minimal-cost route through the TVS network 200. At block 460, the planning system may output data related to at least one of allocations, partitions, and pricing of the product based on the selected route through the TVS network 200.

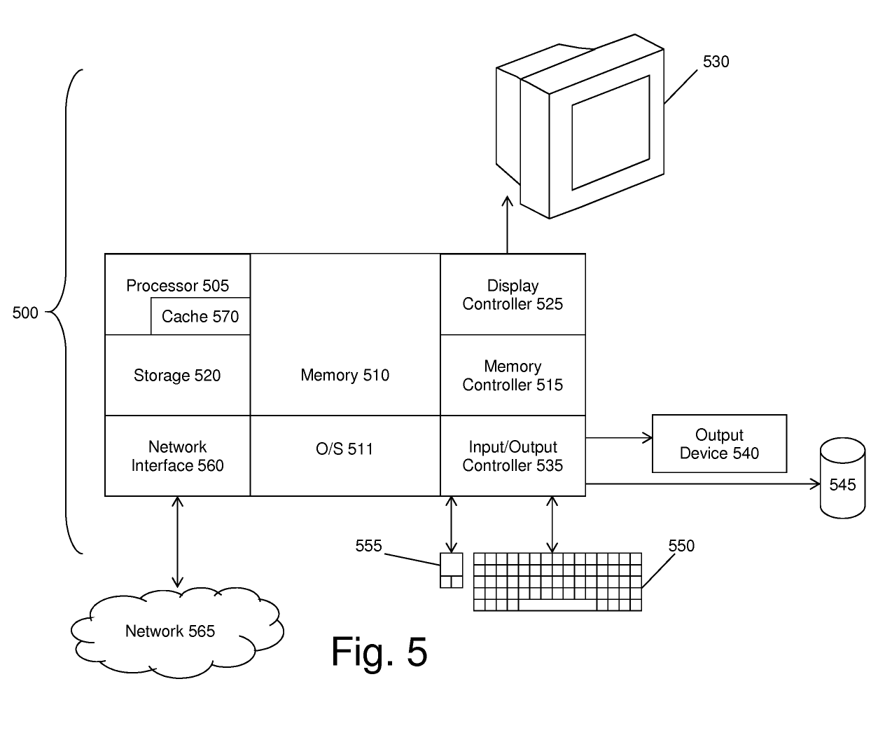

FIG. 5 illustrates a block diagram of a computer system 500 for use in implementing a planning system or method according to some embodiments. The planning systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 500, such as a personal computer, workstation, minicomputer, or mainframe computer.

In an exemplary embodiment, as shown in FIG. 5, the computer system 500 includes a processor 505, memory 510 coupled to a memory controller 515, and one or more input devices 545 and/or output devices 540, such as peripherals, that are communicatively coupled via a local I/O controller 535. These devices 540 and 545 may include, for example, a printer, a scanner, a microphone, and the like. A conventional keyboard 550 and mouse 555 may be coupled to the I/O controller 535. The I/O controller 535 may be, for example, one or more buses or other wired or wireless connections, as are known in the art. The I/O controller 535 may have additional elements, which are omitted for simplicity, such as controllers, buffers (caches), drivers, repeaters, and receivers, to enable communications.

The I/O devices 540, 545 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 505 is a hardware device for executing hardware instructions or software, particularly those stored in memory 510. The processor 505 may be a custom made or commercially available processor, a central processing unit (CPU), an auxiliary processor among several processors associated with the computer system 500, a semiconductor based microprocessor (in the form of a microchip or chip set), a macroprocessor, or other device for executing instructions. The processor 505 includes a cache 570, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 570 may be organized as a hierarchy of more cache levels (L1, L2, etc.).

The memory 510 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 510 may incorporate electronic, magnetic, optical, or other types of storage media. Note that the memory 510 may have a distributed architecture, where various components are situated remote from one another but may be accessed by the processor 505.

The instructions in memory 510 may include one or more separate programs, each of which comprises an ordered listing of executable instructions for implementing logical functions. In the example of FIG. 5, the instructions in the memory 510 include a suitable operating system (OS) 511. The operating system 511 essentially may control the execution of other computer programs and provides scheduling, input-output control, file and data management, memory management, and communication control and related services.

Additional data, including, for example, instructions for the processor 505 or other retrievable information, may be stored in storage 520, which may be a storage device such as a hard disk drive or solid state drive. The stored instructions in memory 510 or in storage 520 may include those enabling the processor to execute one or more aspects of the planning systems and methods of this disclosure.

The computer system 500 may further include a display controller 525 coupled to a display 530. In an exemplary embodiment, the computer system 500 may further include a network interface 560 for coupling to a network 565. The network 565 may be an IP-based network for communication between the computer system 500 and an external server, client and the like via a broadband connection. The network 565 transmits and receives data between the computer system 500 and external systems. In an exemplary embodiment, the network 565 may be a managed IP network administered by a service provider. The network 565 may be implemented in a wireless fashion, e.g., using wireless protocols and technologies, such as WiFi, WiMax, etc. The network 565 may also be a packet-switched network such as a local area network, wide area network, metropolitan area network, the Internet, or other similar type of network environment. The network 565 may be a fixed wireless network, a wireless local area network (LAN), a wireless wide area network (WAN) a personal area network (PAN), a virtual private network (VPN), intranet or other suitable network system and may include equipment for receiving and transmitting signals.

Planning systems and methods according to this disclosure may be embodied, in whole or in part, in computer program products or in computer systems 500, such as that illustrated in FIG. 5.

Technical effects and benefits of some embodiments of the planning system 100 include the use of a TVS network 200 to determine allocations, partitions, and pricing of a product in an omni-channel retail environment.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-7. (canceled)

8. A system comprising:
one or more computer processors configured to:
receive historical transaction data related to a product;
calibrate a demand model to forecast demand for each of one or more zones and each of one or more channels over which the product is sold;
construct a time-and-virtual-space (TVS) network comprising one or more supply nodes and one or more sink nodes, wherein each of the supply nodes represents inventory of the product at a corresponding physical location, and wherein each of the sink nodes represents a calibrated demand for the product; and
determine, based on the TVS network, a low-cost plan for an omni-channel retail environment, wherein the low-cost plan specifies at least one of allocation of the product across physical locations, partitioning of the inventory of the product for virtual sales, and pricing of the product.

9. The system of claim 8, wherein, to construct the TVS network, the one or more computer processors are further configured to incorporate into the TVS network a cost of potential inventory flows through the TVS network.

10. The system of claim 9, wherein, to determine the low-cost plan, the one or more computer processors are further configured to apply a network flow algorithm to the TVS network to identify a low-cost route through the TVS network.

11. The system of claim 8, wherein a first zone of the one or more zones comprises two or more locations of past transactions related to the product.

12. The system of claim 8, wherein the demand model associated with a first zone of the one or more zones is an attraction demand model

13. The system of claim 8, wherein the demand model associated with a first zone of the one or more zones is based, at least in part, on one or more prices offered in one or more channels.

14. The system of claim 8, wherein the one or more computer processors are further configured to:
receive new transaction data related to the product, wherein the new transaction data is a result of executing the low-cost plan;
recalibrate the demand model based on the new transaction data;
modify the TVS network based on the recalibrated demand model; and
determine, based on the TVS network, a second low-cost plan for the omni-channel retail environment, wherein the second low-cost plan specifies at least one of allocation of the product across physical locations, partitioning of the inventory of the product for virtual sales, and pricing of the product.

15. A computer program product for planning in an omni-channel retail environment, the computer program product comprising a computer readable storage medium having program instructions embodied therewith, the program instructions executable by a processor to cause the processor to perform a method comprising:
receiving historical transaction data related to a product;
calibrating a demand model to forecast demand for each of one or more zones and each of one or more channels over which the product is sold;
constructing a time-and-virtual-space (TVS) network comprising one or more supply nodes and one or more sink nodes, wherein each of the supply nodes represents inventory of the product at a corresponding physical location, and wherein each of the sink nodes represents a calibrated demand for the product; and
determining, based on the TVS network, a low-cost plan for an omni-channel retail environment, wherein the low-cost plan specifies at least one of allocation of the product across physical locations, partitioning of the inventory of the product for virtual sales, and pricing of the product.

16. The computer program product of claim 15, wherein the constructing comprises incorporating into the TVS network a cost of potential inventory flows through the TVS network.

17. The computer program product of claim 16, wherein the determining comprises applying a network flow algorithm to the TVS network to identify a low-cost route through the TVS network.

18. The computer program product of claim 15, wherein a first zone of the one or more zones comprises two or more locations of past transactions related to the product.

19. The computer program product of claim 15, wherein the demand model associated with a first zone of the one or more zones is an attraction demand model

20. The computer program product of claim 15, the method further comprising:
receiving new transaction data related to the product, wherein the new transaction data is a result of executing the low-cost plan;
recalibrating the demand model based on the new transaction data;
modifying the TVS network based on the recalibrated demand model; and
determining, based on the TVS network, a second low-cost plan for the omni-channel retail environment, wherein the second low-cost plan specifies at least one of allocation of the product across physical locations, partitioning of the inventory of the product for virtual sales, and pricing of the product.
